(19) United States
(12) Patent Application Publication
(10) Pub. No.: US 2002/0063944 A1
(43) Pub. Date: May 30, 2002

(54) Ultra-high speed optical wavelength converter apparatus for enabling simultaneous extraction of all optical clock signals

(76) Inventors: Dong Hwan Kim, Seoul (KR); Sang Bae Lee, Seoul (KR); Sang Sam Choi, Seoul (KR); Young Tae Byun, Kyungki (KR); Han Il Ki, Seoul (KR)

Correspondence Address: BACON & THOMAS, PLLC, 625 Slaters Lane, 4th Floor, Alexandria, VA, 22314-1176, US

(21) Appl. No.: 09/778,094

(22) Filed: Feb. 7, 2001

(30) Foreign Application Priority Data
Nov. 30, 2000 (KR) 10-2000-72036

(51) Int. Cl. G02F 1/35

(52) U.S. Cl. 359/326

(57) ABSTRACT

The present invention provides an ultra-high speed optical wavelength converter apparatus for enabling extraction of all optical lock signals which implements an ultra-high speed wavelength converter without an external pump light by constructing a semiconductor-fiber ring laser (SFRL) in which a semiconductor optical amplifier (SOA) is used as a laser gain medium and simultaneously implements a clock pulse generator for generating an optical pulse string which is injection mode-locked by an input signal light, and then is phase-locked with an input signal string. According to the present invention, there is proposed an ultra-high speed optical wavelength converter apparatus for enabling extraction of all optical lock signals in which when an output is obtained at a suitable position within a laser resonator after constituting a semiconductor optical laser, a phase lock signal is generated by an injection mode locking laser and a wavelength converter apparatus eliminating the necessity of an external pump light is implemented at another position thereof.

### BACKGROUND OF THE INVENTION

1. Field of the Invention

The present invention relates to an ultra-high speed optical wavelength converter apparatus for enabling simultaneous extraction of all optical clock signals, and more particularly, a technology which simultaneously enables implementation of a ultra-high speed wavelength converter without an external pump light by constructing a semiconductor-fiber ring laser (SFRL) in which a semiconductor optical amplifier (SOA) is used as a laser gain medium, and implementation of a clock pulse generator for generating an optical pulse string which is injection mode-locked by an input signal light, and then is phase-locked with an input signal string.

2. Description of the Related Art

Currently, as a transmission of a ultra-high speed and high capacity information is required, a research on a wavelength division multiplexing (hereinafter, referred to as “WDM”) type optical transmission network system is in progress actively. Since the WDM type optical communication system is a technology which multiplexes a multiplicity of channels by wavelength to divide the multiplexed channels into respective channels after the transmission and reception of a signal, a wavelength conversion technology used at a link point of a communication network or a technology which extracts a phase-locked signal from an input signal at a receiving terminal is one of very essential technologies.

Particularly, for the next optical communication system, more efforts are being made to develop a current partial optical technology toward a complete optical technology. First, as a method for demultiplexing a signal phase-locked from an ultra-high speed input optical pulse string by each channel, an electronic method and an optical phase-locked loop (PLL) technology are used currently, and an injection mode-locked laser of diverse types is employed to extract a phase-locked signal using a complete optical technology without processing a signal electronically.

In the meantime, for a wavelength conversion technology, many researches on a wavelength converter employing a semiconductor optical amplifier (SOA) are carried out because the SOA can be integrated with a semiconductor light source and an optical element as well as is relatively small compared with an optical fiber. As a result, there is a strong possibility that such a wavelength converter will be applied practically to an optical communication system.

In case of a conventional wavelength conversion technology employing the semiconductor optical amplifier (SOA), a wavelength converter is implemented by using a single pass type four wave mixing (FWM), and a pump wave λ₂ of other wavelength besides an input wavelength is required to induce a wavelength conversion of an input optical signal wave λ₁ from the semiconductor optical amplifier (SOA). Accordingly, when two wavelengths λ₁˜λ₂ are injected into the semiconductor optical amplifier (SOA), owing to a nonlinear wave mixing of the two input waves λ₁˜λ₂ within the semiconductor optical amplifier (SOA), a new wavelength, i.e., FWM signal wave generates two new light waves of 2λ₂˜λ₁ and 2λ₁˜λ₂ by a mixing of the two input waves.

However, since it is known that a down-conversion efficiency is higher than an up-conversion efficiency in an FWM efficiency within the semiconductor optical amplifier (SOA), the input wavelength is usually set by a long wavelength rather than the pump so that an FWM signal (2λ₂˜λ₁, λ₁>λ₂) a short wavelength is used as an output signal for processing various optical signals.

At this time, since the strength of the FWM signal is proportional to the square of the strength of the pump wave, but is linearly proportional to the strength of the input wave, the FWM signal keeps linearly phase information as it is, so that SOA-FWM can be used for a detector for detecting a phase of the input signal in the optical PLL system.

Since a wavelength of an external pump light must be varied simultaneously in order to randomly vary a conversed wavelength generated by the single pass type four wave mixing (FWM), there occurs a problem in that an entire system becomes complex and a manufacturing cost is increased.

Like this, a conventional phase lock signal generator and wavelength converter are separate technologies, which have been researched and developed.

### SUMMARY OF THE INVENTION

Therefore, the present invention has been made in view of the above-mentioned problems, and it is an object of the present invention to provide an ultra-high speed optical wavelength converter apparatus for enabling extraction of all optical lock signals which implements an ultra-high speed wavelength converter without an external pump light by constructing a semiconductor-fiber ring laser (SFRL) in which a semiconductor optical amplifier (SOA) is used as a laser gain medium and simultaneously implements a clock pulse generator for generating an optical pulse string which is injection mode-locked by an input signal light, and then is phase-locked with an input signal string.

According to one aspect of the present invention, there is provided an ultra-high speed optical wavelength converter apparatus for enabling extraction of all optical lock signals, comprising:

a 3-dB optical coupling means adapted to separate the strength of an optical signal inputted thereto in the proportion of 50 to 50;

an optical isolating means adapted to transmit an optical wavelength of an optical fiber;

a semiconductor optical amplifying means adapted to amplify the optical wavelength of a semiconductor optical fiber, the semiconductor optical amplifying means functioning as a laser gain medium and a wavelength converter;

an optical wavelength delaying means adapted to adjust the length of the amplified optical wavelength of the semiconductor optical fiber;

a tunable coupling means adapted to vary the strength of a signal outputted therefrom semiconductor optical fiber to adjust a coupling ratio;

a wavelength-tunable broadband pass filtering means adapted to vary the optical wavelength of the semiconductor optical fiber to pass only a laser wavelength; and

a polarization controlling means adapted to control the polarization state of each wavelength for obtaining a maximum four wave mixing (FWM) efficiency,

whereby when an electric power is applied to the semiconductor optical amplifying means, an light of a continuous wave type laser wavelength functioning as an automatic pump light at a center wavelength of the wavelength-tunable broadband pass filtering means without an input signal of an input pump light by the semiconductor optical amplifying means and the wavelength-tunable broadband pass filtering means within a laser resonator is generated as a wavelength-converted optical pulse through the 3 dB optical coupling means and the tunable coupling means, and an input optical pulse string is injected into the 3 dB optical coupler and the length of the laser resonator of the semiconductor fiber laser of the semiconductor optical amplifying means is adjusted to be a multiple of an integer of a repetition frequency of the input optical pulse string through the adjustment of the optical wavelength delaying means to generate a phase-locked laser optical pulse signal.

According to the present invention, there is proposed an ultra-high speed optical wavelength converter apparatus for enabling extraction of all optical lock signals in which when an output is obtained at a suitable position within a laser resonator after constituting a semiconductor optical laser, a phase lock signal is generated by an injection mode locking laser and a wavelength converter apparatus eliminating the necessity of an external pump light is implemented at another position thereof.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a schematic block diagram illustrating the construction of an ultra-high speed optical wavelength converter apparatus for enabling extraction of all optical lock signals according to a preferred embodiment of the present invention;

FIG. 2 is a graph illustrating the comparison of an input pulse string and an optical pulse string which is phase-locked with the input pulse string according to the experimental result of the present invention;

FIGS. 3a and 3b are graphs illustrating the comparison of an input pulse string and an optical pulse string of a wavelength-converted signal according to the experimental result of the present invention; and

FIG. 4 is a graph illustrating the comparison of respective optical spectrums of an input optical signal (1548 nm), a laser optical signal (1544 nm), and a wavelength-converted optical signal (1540 nm) according to the experimental result of the present invention.

### DETAILED DESCRIPTION OF THE PREFERRED EMBODIMENT

Reference will now be made in detail to the preferred embodiment of the present invention.

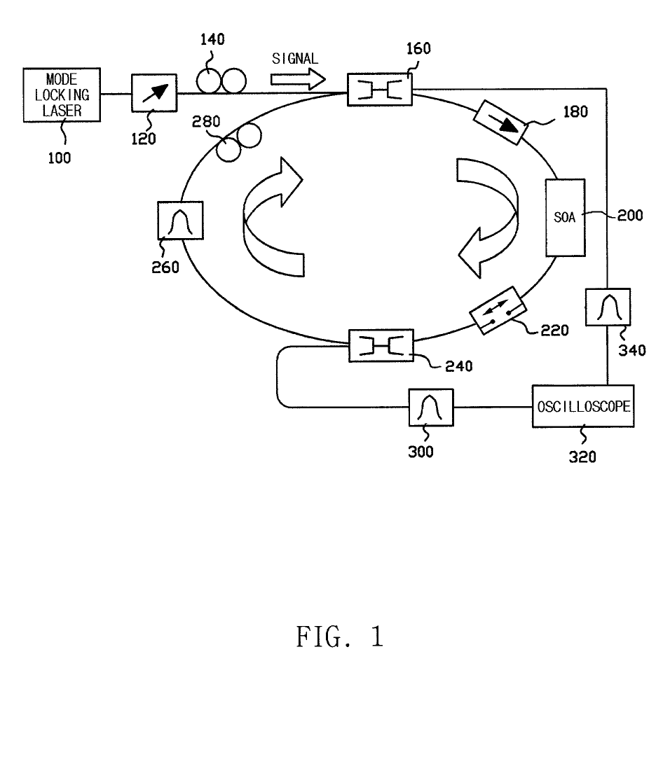

FIG. 1 is a schematic block diagram illustrating the construction of an ultra-high speed optical wavelength converter apparatus for enabling extraction of all optical lock signals according to a preferred embodiment of the present invention.

Referring to FIG. 1, there is shown the ultra-high speed optical wavelength converter apparatus which includes a mode locking laser 100, an optical attenuator 120, first and second polarization controllers (PCs) 140 and 280, a 3-dB optical coupler 160, an optical isolator 180, a semiconductor optical amplifier (SOA) 200, a delay line 220, a tunable coupler 240, a wavelength-tunable broadband pass filter 260, first and second broadband pass filters 300 and 340, and an oscilloscope 340. The optical attenuator 120 is adapted to attenuate an optical output of an optical fiber. The first and second polarization controllers (PCs) 140 and 280 are adapted to control the polarization state of a laser wavelength for obtaining a maximum FWM efficiency in view of a polarization dependency of an FWM using a semiconductor optical amplifier (SOA). The 3-dB optical coupler 160 is adapted to separate an optical strength in the proportion of 50 to 50. The optical isolator 180 is adapted to transmit an optical wavelength of the optical fiber. The semiconductor optical amplifier (SOA) 200, which functions as a laser gain medium and a wavelength converter, is adapted to amplify the optical wavelength of the semiconductor optical fiber. The delay line 220 is adapted to adjust the length of the amplified optical wavelength of the semiconductor optical fiber. The tunable coupler 240 is adapted to vary the strength of a signal outputted therefrom semiconductor optical fiber to adjust a coupling ratio. The wavelength-tunable broadband pass filter 260 is adapted to vary the optical wavelength of the semiconductor optical fiber to pass only a laser wavelength.

Here, the semiconductor optical amplifier (SOA) 200 used as a gain medium of an SOA-fiber laser has a center wavelength with a 40 nm amplification bandwidth near 1.5 μm, a length of 1 mm, a carrier life span of approximately 2 ns, each reflectionless thin film deposited on both surfaces in such a fashion that a reflection factor becomes 10⁻³˜10⁻⁴, a fiber-to-fiber gain of approximately 23 dB at a maximum pumping current of 200 mA, and a saturation output power of 7.5 dB or so.

First, when an experimental equipment as shown in FIG. 1 applies an electric power of 160˜180 mA to the semiconductor optical amplifier (SOA) 200, an light of a continuous wave type laser wavelength is generated at a center wavelength of an wavelength-tunable broadband pass filter 260 without an input optical signal by the semiconductor optical amplifier (SOA) 200 and the wavelength-tunable broadband pass filter 260 within a laser resonator through a 3 dB optical coupler 160 and a tunable coupler 240.

At this time, when an input optical pulse string λ₁ is injected into the 3 dB optical coupler 160 near 1.55 μm at a speed of 10 Gbit/s and the resonator length of the SOA-fiber laser is set to be a multiple of an integer of a repetition frequency of the input optical pulse string λ₁ through the adjustment of the delay line 220, an injection mode-locking is implemented so that the SOA-fiber laser generates a pulse type output signal from the 3 dB optical coupler 160 and the tunable coupler 240.

Here, the tunable coupler 240 functions to control a loss of the laser resonator to resonate a laser. At this point, the repetition frequency of the resonated laser pulse appears in a such a fashion that it becomes a multiple of an integer of a pulse string frequency of the input signal, which is called a harmonically mode locking or a rationally mode locking.

The laser output due to such a mode locking is obtained through the 3 dB optical coupler 160. At this time, the phase-locked laser pulse string and the input pulse string are outputted simultaneously, so when a detector measures the outputted pulse strings by using an optical filter (must be identical with an optical filter in the laser resonator in a center frequency) for selecting only a wavelength of the laser pulse string, only a phase-locked pulse string can be observed through the oscilloscope 320.

Since such an optical signal is an optical signal which is phase-locked with the pulse string of the input signal, it can be used in a demuliplexing device.

In the meantime, a laser wavelength λ₂ generated from the semiconductor optical amplifier (SOA) 200 and a nonlinear four wave mixing (FWM) are induced, so an FWM signal wavelength 2λ₂˜λ₁ and the laser wavelength λ₂ are outputted through the tunable coupler 240. Accordingly, only the FWM signal wavelength 2λ₂˜λ₁ can be obtained from an output terminal of the tunable coupler 240 through the use of an optical filter for passing only an FWM wavelength.

In addition, since a wavelength-tunable broadband pass filter 260 for passing only the laser wavelength is disposed at the next stage of the tunable coupler 240 in the laser resonator, the newly generated FWM signal wavelength 2λ₂˜λ₁ cannot undergo a feedback process in the laser resonator again. As a result, only the laser wavelength acting as a pump wave is fed-back into the laser resonator.

Also, a second polarization controller (PC) 280 positioned in the laser resonator functions to make the polarization state of the laser wavelength coincident with that of the input wave for maximizing an efficiency of four wave mixing (FWM).

The tunable coupler 240 used in the present invention for adjusting a coupling ratio was designed to control a loss of the SOA-optical laser to adjust a gain ratio of the semiconductor optical amplifier 200 so that the strength of the FWM signal outputted from the tunable coupler 240 can be adjusted.

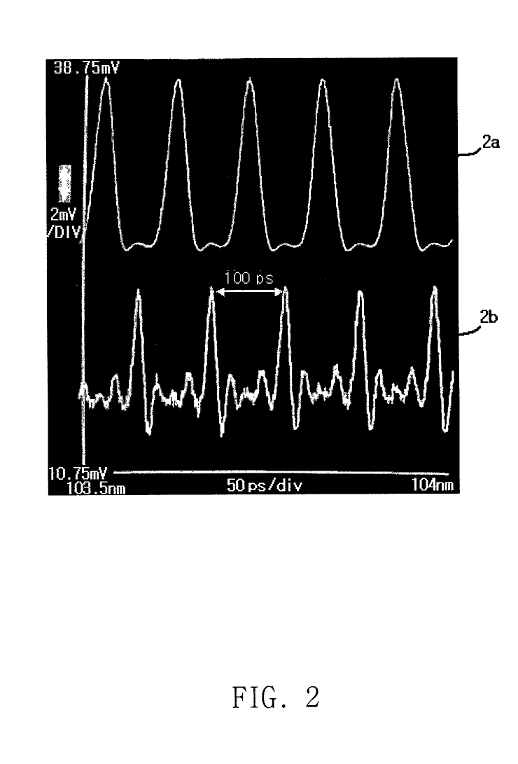

FIG. 2 is a graph illustrating the comparison of an input pulse string and an optical pulse string which is phase-locked with the input pulse string according to the experimental result of the present invention;

Referring to FIG. 2, there are shown an input optical pulse string of 5 Gbit/s (FIG. 2a) and 10 Gbit/s (FIG. 2b) inputted to a multipurpose optical communication module implemented by the present invention and a phase-locked optical pulse string of 10 Gbit/s which is outputted from the 3-dB optical coupler 160.

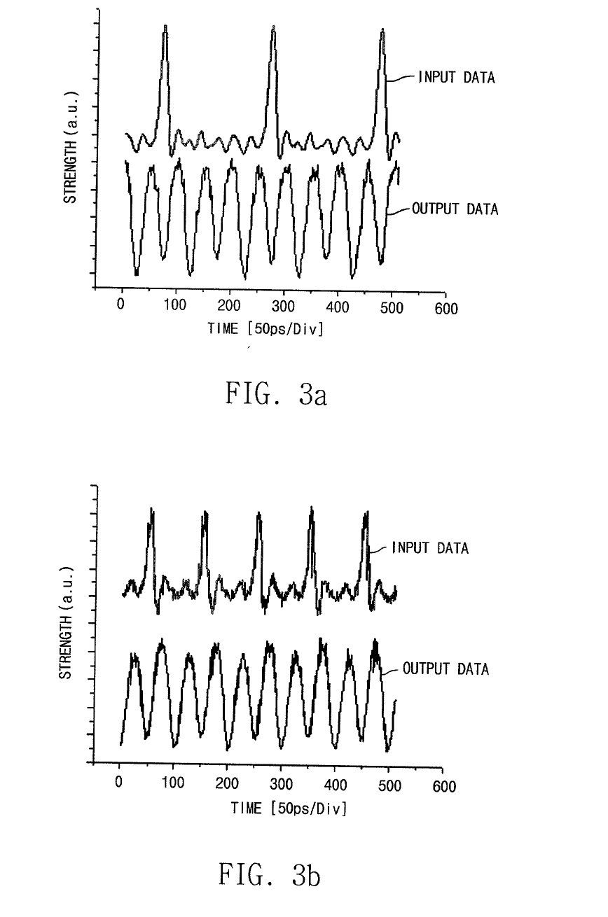

FIGS. 3a and 3b are graphs illustrating the relationship between a time and a strength of output data obtained from the tunable coupler 240 according to the experimental result of the present invention, in which FIG. 3a is a graph illustrating an optical pulse string of a wavelength-converted signal and FIG. 3b is a graph illustrating an input pulse string.

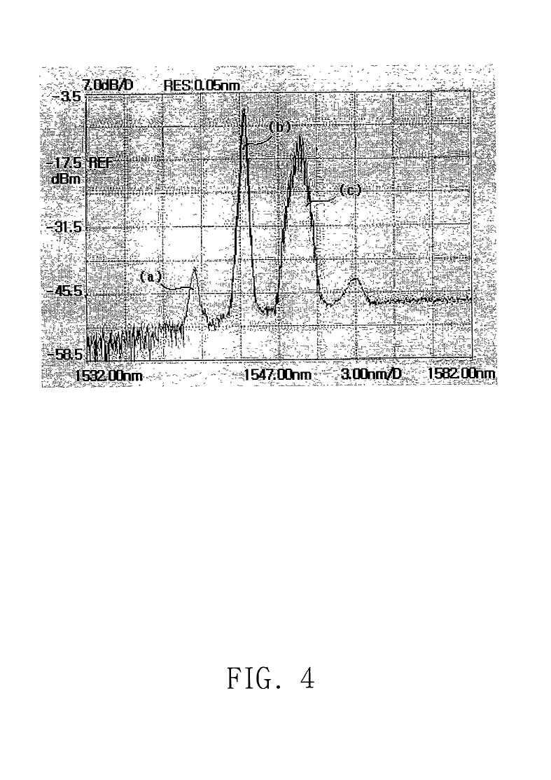

FIG. 4 is a graph illustrating spectrums of respective optical wavelengths outputted from an ultra-high speed optical wavelength converter apparatus according to the present invention, i.e., respective spectrums of (a) an FWM wavelength-converted optical wavelength of 10 Gbps FWM, (b) an optical wavelength of a semiconductor-fiber ring laser (SFRL), and (c) an input optical wavelength of 100 Gbps.

Particularly, in case of a spectrum of the input optical wavelength (c), since a mode-locked optical fiber is used, it can be seen from the graph that a wavelength bandwidth is great relatively.

As can be seen from the foregoing, according to the ultra-high speed optical wavelength converter apparatus for enabling extraction of all optical lock signals, when an output is obtained at a suitable position within a laser resonator after constituting an SOA-optical laser, a wavelength is varied at a range of 1.55 μm, and an ultra high speed optical wavelength converter apparatus eliminating the necessity of an external pump light and generation of an optical pulse which is phase-locked with an input optical pulse string are implemented simultaneously, so the present invention can be used as both an ultra-high speed optical wavelength converter and a phase lock signal generator in a WDM optical communication system over 10 Gbps grade.

While this invention has been described in connection with what is presently considered to be the most practical and preferred embodiment, it is to be understood by those skilled in the art that the invention is not limited to the disclosed embodiment, but, on the contrary, it is intended to cover various modifications within the spirit and scope of the appended claims.

What is claimed is:

1. An ultra-high speed optical wavelength converter apparatus for enabling extraction of all optical lock signals, comprising:
a 3-dB optical coupling means adapted to separate the strength of an optical signal inputted thereto in the proportion of 50 to 50;
an optical isolating means adapted to transmit an optical wavelength of an optical fiber;
a semiconductor optical amplifying means adapted to amplify the optical wavelength of a semiconductor optical fiber, the semiconductor optical amplifying means functioning as a laser gain medium and a wavelength converter;
an optical wavelength delaying means adapted to adjust the length of the amplified optical wavelength of the semiconductor optical fiber;
a tunable coupling means adapted to vary the strength of a signal outputted therefrom semiconductor optical fiber to adjust a coupling ratio;
a wavelength-tunable broadband pass filtering means adapted to vary the optical wavelength of the semiconductor optical fiber to pass only a laser wavelength; and
a polarization controlling means adapted to control the polarization state of each wavelength for obtaining a maximum four wave mixing (FWM) efficiency,
whereby when an electric power is applied to the semiconductor optical amplifying means, an light of a continuous wave type laser wavelength functioning as an automatic pump light at a center wavelength of the wavelength-tunable broadband pass filtering means without an input signal of an input pump light by the semiconductor optical amplifying means and the wavelength-tunable broadband pass filtering means within a laser resonator is generated as a wavelength-converted optical pulse through the 3 dB optical coupling means and the tunable coupling means, and an input optical pulse string is injected into the 3 dB optical coupler and the length of the laser resonator of the semiconductor fiber laser of the semiconductor optical amplifying means is adjusted to be a multiple of an integer of a repetition frequency of the input optical pulse string through the adjustment of the optical wavelength delaying means to generate a phase-locked laser optical pulse signal.

2. The system according to claim 1, wherein the input optical pulse string is injected into the 3 dB optical coupler at a speed of 10 Gbit/s when the 3 dB optical coupler is at 1.55 μm to generate a wavelength-converted optical pulse of 10 Gbit and a phase-locked optical pulse string.
